(19) United States
(12) Patent Application Publication
(10) Pub. No.: US 2022/0412263 A1
(43) Pub. Date: Dec. 29, 2022

(54) ENGINE USING HEATED AND TURBO-EXPANDED AMMONIA FUEL

(71) Applicant: Raytheon Technologies Corporation, Farmington, CT (US)

(72) Inventors: Lance L. Smith, West Hartford, CT (US); Peter Cocks, South Glastonbury, CT (US); Joseph B. Staubach, Colchester, CT (US)

(21) Appl. No.: 17/896,431

(22) Filed: Aug. 26, 2022

Related U.S. Application Data
(63) Continuation of application No. 16/858,858, filed on Apr. 27, 2020.

(51) Int. Cl. F02C 7/224; F02C 3/04; F02C 3/24; F23R 3/30

(52) U.S. Cl. CPC F02C 7/224; F02C 3/04; F02C 3/24; F23R 3/30; F05D 2220/32; F05D 2240/36

(57) ABSTRACT

An energy extraction system according to an exemplary embodiment of this disclosure, among other possible things includes an ammonia fuel storage tank assembly that is configured to store a liquid ammonia fuel, a thermal transfer assembly that is configured to transform the liquid ammonia fuel into a vaporized ammonia based fuel, a turbo-expander that is configured to expand the vaporized ammonia based fuel to extract work, and an energy conversion device that is configured to use the vaporized ammonia based fuel from the turbo-expander to generate a work output.

### CROSS-REFERENCE TO RELATED APPLICATIONS

This application is a continuation of U.S. patent application Ser. No. 16/858,858 filed on Apr. 27, 2020.

### BACKGROUND

A gas turbine engine typically mixes a carbon based fuel with air within a combustor where it is ignited to generate a high-energy exhaust gas flow. The high-energy exhaust gas flow includes carbon that is eventually exhausted into the environment. Alternative engine structures and fuels may aid in the reduction and/or elimination of carbon emissions. One such alternative fuel is ammonia. Ammonia requires non-traditional storage structures and systems to practically leverage positive environmental and performance aspects.

Turbine engine manufacturers continue to seek further improvements to engine performance including improvements to reduce environmental impact while improving propulsive efficiencies.

### SUMMARY

An energy extraction system according to an exemplary embodiment of this disclosure, among other possible things includes an ammonia fuel storage tank assembly that is configured to store a liquid ammonia fuel, a thermal transfer assembly that is configured to transform the liquid ammonia fuel into a vaporized ammonia based fuel, a turbo-expander that is configured to expand the vaporized ammonia based fuel to extract work, and an energy conversion device that is configured to use the vaporized ammonia based fuel from the turbo-expander to generate a work output.

In a further embodiment of the foregoing, the energy extraction system further includes a liquid pump that is configured to increase a pressure of the liquid ammonia fuel to a pressure that is greater than a pressure of the liquid ammonia fuel in the ammonia fuel storage tank.

In a further embodiment of any of the foregoing, the ammonia fuel storage tank assembly is configured to store the liquid ammonia fuel under a temperature and pressure that is different than an ambient temperature and pressure.

In a further embodiment of any of the foregoing, the energy conversion device includes a combustor. The vaporized ammonia based fuel is mixed with air and ignited in the combustor to generate a high energy exhaust gas flow that is expanded through a turbine.

In a further embodiment of any of the foregoing, the turbo-expander is coupled to drive a compressor in flow communication with the combustor. The compressor pressurizes air to be mixed with the vaporized ammonia based fuel in the combustor.

In a further embodiment of any of the foregoing, the energy extraction system further includes a liquid pump that is configured to increase a pressure of the liquid ammonia fuel to a first pressure that is greater than a pressure of the liquid ammonia fuel in the ammonia fuel storage tank. The first pressure is greater than a pressure of the vaporized ammonia based fuel that is communicated to the combustor.

In a further embodiment of any of the foregoing, the thermal transfer assembly is in communication with a core flow to the turbine.

In a further embodiment of any of the foregoing, the thermal transfer assembly is configured to heat the ammonia fuel to decompose at least a portion of the ammonia fuel into hydrogen and nitrogen.

In a further embodiment of any of the foregoing, the thermal transfer assembly is disposed before the turbo-expander.

In a further embodiment of any of the foregoing, the energy conversion device includes a fuel cell that is configured to generate electric power to drive an electric motor.

An engine assembly according to an exemplary embodiment of this disclosure, among other possible things includes an ammonia fuel storage tank assembly that stores ammonia fuel in a liquid form, a thermal transfer assembly to transform the liquid ammonia fuel into a vaporized ammonia based fuel, a turbo-expander through which the vaporized ammonia based fuel is expanded to extract a work output, a compressor section that is driven by the turbo-expander and configured to pressurize a core air flow mixed with the vaporized ammonia based fuel in a combustor to generate a high energy exhaust gas flow, and a free power turbine that is driven by expansion of the high energy exhaust gas flow and configured to drive an output shaft.

In a further embodiment of any of the foregoing, the engine assembly includes a liquid pump to increase a pressure of the ammonia fuel in the liquid form to a first pressure greater than a pressure of the ammonia fuel within the ammonia fuel storage tank and the ammonia fuel storage tank assembly contains the ammonia fuel that is in the liquid form under a predefined temperature and pressure that is different than an ambient temperature and pressure.

In a further embodiment of any of the foregoing, the thermal transfer assembly is in thermal communication with the high energy exhaust gas flow and heats the ammonia fuel to decompose the ammonia fuel into hydrogen and nitrogen.

In a further embodiment of any of the foregoing, the engine assembly includes an electric motor that is driven by electric power that is generated by the fuel cell.

A method of operating an energy extraction system according to an exemplary embodiment of this disclosure, among other possible things includes transforming an ammonia fuel in a liquid form to a vaporized ammonia based fuel, expanding the vaporized ammonia based fuel through a turbo-expander, communicating the vaporized ammonia based fuel from the turbo-expander to an energy conversion device, and reacting the vaporized ammonia based fuel within the energy conversion device to generate a work output.

In a further embodiment of any of the foregoing, the method includes pressurizing the ammonia fuel in the liquid form to a first pressure greater than a pressure of the ammonia fuel stored in a fuel storage tank.

In a further embodiment of any of the foregoing, the method includes transforming the ammonia fuel within a thermal transfer assembly in thermal communication with a heat source.

In a further embodiment of any of the foregoing, the energy conversion device includes a combustor where the vaporized ammonia based fuel is mixed with air and ignited to generate a high energy exhaust gas flow.

In a further embodiment of any of the foregoing, the turbo-expander is coupled to a compressor that is configured to pressurize air and communicate the pressurized air to the combustor.

In a further embodiment of any of the foregoing, the method includes transforming the ammonia fuel in liquid form within a thermal transfer assembly in thermal communication with a core flow.

In a further embodiment of any of the foregoing, the method includes decomposing at least a portion of the ammonia fuel into hydrogen and nitrogen with exposure to heat in the thermal transfer assembly.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example ammonia fuel powered turbine engine.

FIG. 2 is a schematic view of another example ammonia fuel powered turbine engine.

FIG. 3 is a schematic view of ammonia fuel powered engine assembly including a fuel cell.

### DETAILED DESCRIPTION

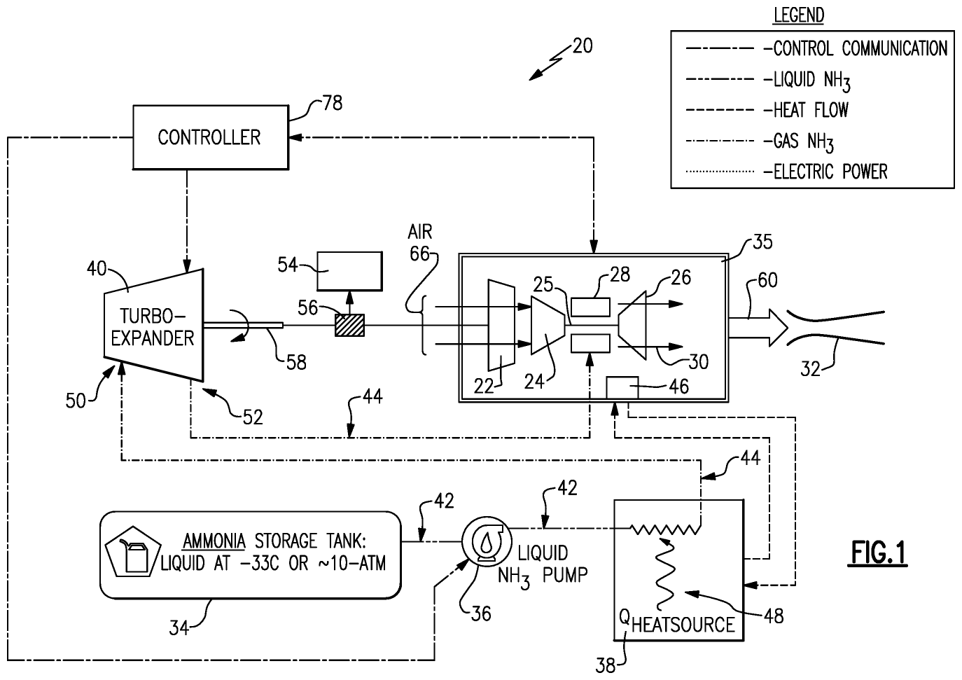

FIG. 1 schematically illustrates one example disclosed alternate fueled turbine engine assembly 20. The engine assembly 20 uses a vaporized ammonia based fuel mixed with a core gas flow 66 in a combustor 28 to generate a high energy gas flow 30 that expands through a turbine section 26 to drive a compressor section 24 of a main turbine engine 35. The disclosed vaporized ammonia based fuel may include ammonia, decomposition products of ammonia and/or a mixture of ammonia and decomposition products.

Ammonia (NH₃) does not contain carbon, but does have a fuel energy similar to alcohols such as methanol. Ammonia can also be transported and stored in liquid form at moderate pressure and temperature. For example, ammonia is a liquid at a pressure of about 8.5 atm and a temperature of 20° C. Alternatively, ammonia is a liquid at a pressure of 1 atm and a temperature of −33° C. These properties make ammonia attractive as alternate fuel that produces no carbon dioxide.

The disclosed engine assembly 20 uses heat to transform ammonia fuel in a liquid state into a vaporized ammonia based fuel. The vaporized ammonia based fuel 44 is expanded through a turbo-expander 40 to create shaft work and then delivered to the combustor 28 to generate additional power and shaft work utilized to generate a thrust producing flow 60 by the main engine 35.

The vaporized ammonia based fuel 44 is generated from a liquid ammonia fuel 42 stored in a fuel storage tank 34. The fuel storage tank 34 stores ammonia fuel 42 in a liquid state at a pressure and temperature that maintains the ammonia fuel 42 in a liquid state. The specific pressure and temperature required to maintain the ammonia fuel 42 in the liquid state may vary in different embodiments. In one disclosed example, the ammonia fuel 42 is maintained in the liquid state by storing at a temperature below about −33° C. and at a pressure at or below approximately 1 atm. In another disclosed embodiment, the ammonia fuel 42 is maintained in the fuel storage tank at a pressure of about 8.5 atm at a temperature of 20° C. In another disclosed embodiment, the ammonia fuel is maintained in a liquid form at a pressure of about 1 atm and a temperature of about −33° C. It should be appreciated that the specific temperature and pressure of ammonia may vary depending on application specific conditions.

Ammonia fuel 42 in a liquid state is pressurized to a first pressure by a liquid pump 36. The liquid pump 36 raises the pressure to a point where the ammonia fuel 42 is of a pressure greater than is needed for communication into the combustor 28. The pressurized liquid ammonia fuel 42 is then heated within a thermal transfer assembly 38. Thermal energy is drawn from various heat sources including heat producing engine systems as is schematically shown at 46. Heat producing systems can include electric systems, combustion systems, turbine systems, lubrication systems and air cooling systems. The work required to pressurize ammonia fuel 42 in a liquid state to a high pressure is relatively small compared to the work created by turbo-expanding the heated, gaseous ammonia (or its decomposition products) in the turbo-expander 40. As a result, the heat used to raise the temperature of the ammonia fuel produces additional work that can be captured to reduce the load on the main engine 35 that in turn enables more work or thrust to be produced from a given quantity of fuel. Additionally, heat producing systems onboard an aircraft may also be utilized to supply heat required to vaporize the ammonia fuel 42.

Ammonia fuel exhausted from the thermal transfer assembly 38 is in a gas state and is communicated to an inlet 50 of a turbo-expander 40 and exhausted through an outlet 52 to the combustor 28. The turbo-expander 40 drives a shaft 58 that is coupled though a mechanical coupling 56 to drive engine and/or aircraft systems as is schematically shown at 54. The engine and/or aircraft systems can include pumps, generators, gearboxes and any other systems that would normally be powered through a coupling to a main engine shaft.

In this disclosed example, the turbo-expander 40 is further coupled to drive a low pressure compressor section 22 of the main turbine engine 35. As is schematically shown, the high pressure compressor section 24 is coupled by way of shaft 25 to a high pressure turbine section 26. The high pressure compressor section 24, combustor 28 and high pressure turbine 26 provide a gas generator that produces the high energy exhaust flow 30 utilized to produce thrust. Any load placed on the main engine 35 reduces the amount of thrust that can be produced. The turbo-expander 40 uses energy in the vaporized ammonia based fuel 44 to reduce the amount of fuel required to produce the exhaust flow, thereby improving engine efficiency.

In the main engine 35, the thrust producing flow 60 can be directed through a nozzle 32 to generate thrust. Additionally, the exhaust gas flow 30 can be used to drive a turbine that in turn would drive a fan to produce a bypass flow that increases thrust. A controller 78 is provided to control operation of the pump 36 and the turbo-expander 40 to desired engine operating demands and conditions. It should be appreciated, that the main engine 35 is shown schematically and that other structures and engine configurations such as 2-spool, 3-spool and geared turbofan engines would benefit from this disclosure and are within the contemplation and scope of this disclosure. Moreover, a land based turbine engine would also benefit from application of the features of this disclosure.

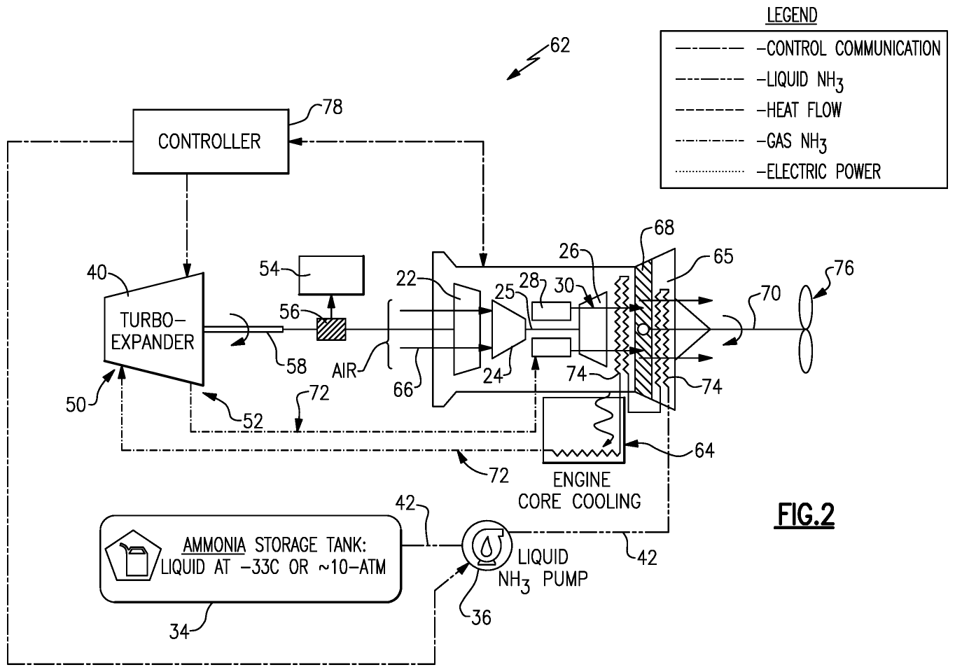

Referring to FIG. 2, another example engine assembly 62 is schematically shown. The example engine assembly 62 includes the turbo-expander 40 that produces additional shaft work from the expansion of products from the cracking or decomposition of an ammonia based fuel 72. The engine assembly 62 includes a main engine 65 and a thermal transfer system 64 that utilizes heat from the high energy exhaust gas flow 30 generated in the combustor 28 to thermally decompose the ammonia fuel 42. In this example, the thermal transfer system 64 includes heat exchangers 74 in thermal communication with the exhaust gas flow 30 generated by the combustor 28. The higher heat energy generated aft of the combustor 28 elevates the temperature of the liquid ammonia fuel 42 and helps to decompose the ammonia into hydrogen and nitrogen according to the chemical equation:

NH₃→½N₂+3(½H₂)

Depending upon the final temperature and pressure and the rate of decomposition in the presence of a catalyst, all of the ammonia or some portion of the ammonia may become cracked to form nitrogen and hydrogen. Cracking the ammonia fuel into nitrogen and hydrogen captures waste heat and provides an increased amount of work in the turbo-expander 40.

Moreover, because the cracking process is endothermic, the cracked fuel has increased fuel chemical energy and can therefore provide increased engine work output or thrust output without increased fuel flow and thereby improves engine fuel efficiency. The cracking process is endothermic and therefore additional heat absorption capacity becomes available at a given fuel temperature, thereby enabling greater heat absorption before the fuel temperature approaches the temperature of the heat source.

The cracking process increases the number of moles, with one mole of ammonia NH₃ becoming two moles of cracked gas, per NH₃→½ N₂+3(½ H₂), the resulting cracked gas occupies more volume and can provide more work output when turbo-expanded than can the original ammonia fuel for the same turbo-expander inlet temperature and pressure conditions. Because the cracked gas is less dense and has a higher specific heat capacity it can produce more work as enthalpy is extracted during turbo-expansion.

Furthermore, the cracking process changes the chemical composition of the ammonia fuel and thereby also changes its vapor-liquid equilibrium properties which provide greater turbo-expansion of the cracked gas. As appreciated, for a given pressure, the saturation temperature, where vapor begins to condense to liquid, is much lower for H₂ and N₂ than it is for NH₃. As a result, the conversion of some or all of the NH₃ to H₂ and N₂ allows a larger temperature drop and more work extraction across the turbo-expander 40 without crossing the vapor-liquid equilibrium line than would be possible with pure NH₃ as the working fluid in the turbo-expander.

This property can be advantageously used when cracking is included in the process by pumping the liquid fuel to a higher pressure before it is heated and cracked, thereby enabling a greater pressure and temperature drop during turbo-expansion. Cracking at least some of the ammonia fuel to form hydrogen further improves the flammability of the fuel, thus facilitating both ignition and stabilization of combustion in the main engine 65.

The example main engine 65 includes a free power turbine 68 that drives an output shaft 70. The free power turbine 68 is driven by expansion of the exhaust gas flow 30 aft of the high pressure turbine 24. The free power turbine 68 is not coupled to drive other structures of the main engine 65 and therefore may more efficiently drive accessory components or a propulsive fan 76, at their desired speeds, as is schematically shown. As appreciated, some portion of shaft power from a turbine is typically required to drive accessory components and/or other compressor sections such as the low pressure compressor 22. However, the turbo-expander 40 uses energy from the cracked ammonia based fuel 72 to drive an accessory component 54 and/or the low pressure compressor 22. Accordingly, power generated by the power turbine 68 to drive the shaft 70 is increased and the overall engine efficiency is improved.

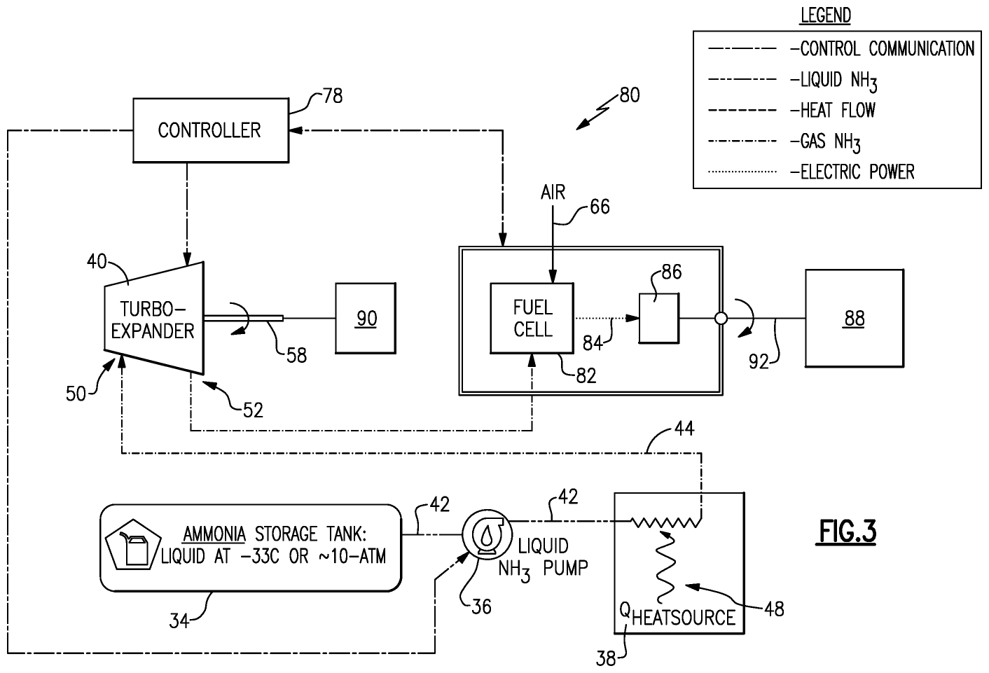

Referring to FIG. 3, another example engine assembly 80 is schematically shown. The engine assembly 80 includes a fuel cell system 82 that is supplied with vaporized ammonia based fuel 44 to generate electric power schematically shown at 84. The fuel cell system 82 may be a direct-ammonia fuel cell, or a system that includes conversion of ammonia to hydrogen for use in a hydrogen fuel cell. The electric power 84 in this example is utilized to drive an electric motor 86. The electric motor 86 includes an output shaft 92 that drives an engine and/or aircraft system schematically indicated at 88. Vaporized ammonia based fuel 44 expands through the turbo-expander 40 to power the shaft 58. The shaft 58 can be coupled to drive various needed aircraft and/or engine accessories as is schematically shown at 90. The aircraft/engine accessory 90 may be a pump, a generator and/or any other structure utilizing rotary shaft power. The heat 48 for vaporizing the ammonia fuel 42 may be provided by any heat producing structure or device associated with an engine, fuel cell system, and/or aircraft. The disclosed engine assembly 80 may be utilized as a standalone engine or as an accessory unit in concert with a turbine engine to increase overall engine efficiency.

Accordingly, the disclosed assemblies provide for the advantageous use of ammonia fuel to improve engine efficiency and reduce carbon emission. The disclosed systems use advantageous properties of ammonia to convert ammonia fuel into useful work prior to combustion that enables improved engine efficiencies.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. An energy extraction system, comprising:
an ammonia fuel storage tank assembly configured to store a liquid ammonia fuel;
a thermal transfer assembly configured to transform the liquid ammonia fuel into a vaporized ammonia based fuel, the thermal transfer assembly is in communication with a high energy exhaust gas flow;
a turbo-expander configured to expand the vaporized ammonia based fuel to extract work; and
a combustor where the vaporized ammonia based fuel is mixed with air and ignited in the combustor to generate the high energy exhaust gas flow that is expanded through a turbine.

2. The energy extraction system as recited in claim 1, further comprising a liquid pump configured to increase a pressure of the liquid ammonia fuel to a pressure greater than a pressure of the liquid ammonia fuel in the ammonia fuel storage tank.

3. The energy extraction system as recited in claim 1, wherein the ammonia fuel storage tank assembly is configured to store the liquid ammonia fuel under a temperature and pressure that is different than an ambient temperature and pressure.

4. The energy extraction system as recited in claim 1, wherein the turbo-expander is coupled to drive a compressor in flow communication with the combustor, the compressor pressurizing air to be mixed with the vaporized ammonia based fuel in the combustor.

5. The energy extraction system as recited in claim 4, further comprising a liquid pump configured to increase a pressure of the liquid ammonia fuel to a first pressure greater than a pressure of the liquid ammonia fuel in the ammonia fuel storage tank, wherein the first pressure is greater than a pressure of the vaporized ammonia based fuel communicated to the combustor.

6. The energy extraction system as recited in claim 1, wherein the thermal transfer assembly is configured to heat the ammonia fuel to decompose at least a portion of the ammonia fuel into hydrogen and nitrogen.

7. The energy extraction system as recited in claim 1, including a free power turbine driven by expansion of the high energy exhaust gas flow and configured to drive an output shaft.

8. The energy extraction system as recited in claim 7, wherein the thermal transfer assembly includes a first heat exchanger disposed aft of the turbine and a second heat exchanger deposed aft of the power turbine where the ammonia based fuel is in communication with a portion of the high energy exhaust gas flow exhausted through the power turbine.

9. The energy extraction system as recited in claim 8, wherein the free power turbine drives a propulsive fan.

10. The energy extraction system as recited in claim 1, wherein the energy conversion device includes a fuel cell configured to generate electric power to drive an electric motor.

11. An engine assembly comprising:
an ammonia fuel storage tank assembly storing ammonia fuel in a liquid form;
a thermal transfer assembly to transform the liquid ammonia fuel into a vaporized ammonia based fuel;
a turbo-expander through which the vaporized ammonia based fuel is expanded to extract a work output;
a compressor section driven by the turbo-expander and configured to pressurize a core air flow mixed with the vaporized ammonia based fuel in a combustor to generate a high energy exhaust gas flow; and
a free power turbine driven by expansion of the high energy exhaust gas flow and configured to drive an output shaft.

12. The engine assembly as recited in claim 11, including a liquid pump to increase a pressure of the ammonia fuel in the liquid form to a first pressure greater than a pressure of the ammonia fuel within the ammonia fuel storage tank and the ammonia fuel storage tank assembly contains the ammonia fuel that is in the liquid form under a predefined temperature and pressure that is different than an ambient temperature and pressure.

13. The engine assembly as recited in claim 11, wherein the thermal transfer assembly is in thermal communication with the high energy exhaust gas flow and heats the ammonia fuel to decompose the ammonia fuel into hydrogen and nitrogen.

14. The engine assembly as recited in claim 12, including an electric motor driven by electric power generated by the fuel cell.

15. A method of operating an energy extraction system, comprising:
transforming an ammonia fuel in a liquid form to a vaporized ammonia based fuel within a thermal transfer assembly in thermal communication with a core flow;
expanding the vaporized ammonia based fuel through a turbo-expander;
communicating the vaporized ammonia based fuel from the turbo-expander to an energy conversion device; and
reacting the vaporized ammonia based fuel within the energy conversion device to generate a work output.

16. The method as recited in claim 15, including pressurizing the ammonia fuel in the liquid form to a first pressure greater than a pressure of the ammonia fuel stored in a fuel storage tank.

17. The method as recited in claim 16, wherein the energy conversion device comprises a combustor where the vaporized ammonia based fuel is mixed with air and ignited to generate a high energy exhaust gas flow.

18. The method as recited in claim 17, wherein the turbo-expander is coupled to a compressor configured to pressurize air and communicate the pressurized air to the combustor.

19. The method as recited in claim 15, including decomposing at least a portion of the ammonia fuel into hydrogen and nitrogen with exposure to heat in the thermal transfer assembly.
